(19) United States
(12) Patent Application Publication
(10) Pub. No.: US 2018/0364131 A1
(43) Pub. Date: Dec. 20, 2018

(54) TESTING APPARATUS

(71) Applicant: OptoFidelity Oy, Tampere (FI)

(72) Inventors: Kimmo Jokinen, TAMPERE (FI); Tommi Björk, TAMPERE (FI); Juha Koljonen, TAMPERE (FI); Tuomas Nieminen, TAMPERE (FI)

(21) Appl. No.: 15/850,504

(22) Filed: Dec. 21, 2017

Related U.S. Application Data
(60) Provisional application No. 62/519,447, filed on Jun. 14, 2017.

(51) Int. Cl. G01M 11/08; G01M 99/00

(52) U.S. Cl. CPC G01M 11/081; G01N 2203/0042; G01N 2203/06; G01M 99/004

(57) ABSTRACT

A testing apparatus for testing a device. In accordance with an embodiment the testing apparatus includes a base part; a testing head; first movement rails attached with the base part; a first movement platform positioned on top of the first movement rails adapted to enable movement of the first movement platform in a first direction; a second movement platform attached with the first movement platform so that the second movement platform is adapted to be movable in a second direction transverse to the first direction; a first support adapted to be movable in a third direction transverse to the first direction and the second direction; a movement mechanism for moving the testing head; and a second support attached with the vertical support for supporting the movement mechanism and the testing head. The movement mechanism comprises a first axis for pivoting the testing head; a second axis for tilting the testing head; and a third axes for rotating the testing head.

### TECHNICAL FIELD

The aspects of the disclosed embodiments relate to a testing apparatus.

### BACKGROUND

This section is intended to provide a background or context to the disclosed embodiments that are recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Automated testing apparatuses for testing electronic devices, such as portable electronic devices, exist in which testing personnel puts the device to be tested on a test jig and then puts the test jig onto a test bench at a predetermined location. The testing apparatus may comprise a robotic arm which performs tests adapted for the particular device to be tested.

Many robotic arms have several arm sections which are hinged with each other so that a gripping tool, a stylus etc. can be moved in different positions. Such an arrangement may enable six degrees of freedom for moving the gripping tool or stylus. However, this kind of arrangement is not practicable when testing virtual reality (VR) equipment, augmented reality (AR) equipment or mixed/merged reality (MR) equipment, such as virtual reality glasses. Moreover, possible inaccuracies in movements of the hinged portions and couplings between the hinged portions may accumulate towards farther portions of the robotic arm. Thus, controlling the location of the gripping tool or stylus may not be accurate enough.

Many robotic arms also have the feature known as kinetic singularity, which makes it more complicated to accurately move the gripping tool, stylus or some other tool accurately from one location to another location. The kinetic singularity means a position of the robotic arm where continuation of the movement to the same direction is not possible without positioning many of the joints of the robotic arm to another position. For example, an internal singularity may be caused by an alignment of the robot's axes in space. It may happen that two axes become aligned in space, wherein counterrotation of one of the axes may prevent rotation of the other axle.

### SUMMARY

An aim of the present disclosure is to provide a testing apparatus providing at least six degrees of freedom for moving a device to be tested.

Some embodiments provide a testing apparatus for testing a device. In some embodiments the testing apparatus comprises a platform enabling six degrees of freedom movement for a testing head.

Various aspects of examples of the present disclosure are provided in the detailed description.

According to an aspect, there is provided a testing apparatus comprising:

a base part;

a testing head;

a first movement platform positioned on top of the base part adapted to be movable in a first direction with respect to the base part;

a second movement platform attached with the first movement platform so that the second movement platform is adapted to be movable in a second direction transverse to the first direction with respect to the base part;

a first support adapted to be movable in a third direction transverse to the first direction and the second direction;

a movement mechanism for moving the testing head;

a second support attached with the vertical support for supporting the movement mechanism and the testing head;

wherein the movement mechanism comprises:

a first axis for pivoting the testing head;

a second axis for tilting the testing head; and

a third axes to rotate the testing head.

According to another aspect there is provided a method for testing a device by a testing apparatus, wherein the testing apparatus comprises:

a base part;

a testing head;

a first movement platform positioned on top of the base part adapted to be movable in a first direction with respect to the base part;

a second movement platform attached with the first movement platform so that the second movement platform is adapted to be movable in a second direction transverse to the first direction with respect to the base part;

a first support adapted to be movable in a third direction transverse to the first direction and the second direction;

a movement mechanism for moving the testing head;

a second support attached with the vertical support for supporting the movement mechanism and the testing head;

wherein the method comprises:

instructing the device to run an application for producing video information on a display of the device or audio information by the device or both;

moving the testing head in at least one direction;

capturing by the testing apparatus information produced by the device;

examining the captured information to determine response of the device to the movement of the testing head.

According to yet another aspect there is provided a testing apparatus comprising:

a base part;

a testing head;

a first movement platform positioned on top of the base part;

means for moving the first movement platform in a first direction with respect to the base part;

a second movement platform attached with the first movement platform;

means for moving the second movement platform in a second direction transverse to the first direction with respect to the base part;

a first support;

means for moving the first support in a third direction transverse to the first direction and the second direction;

means for moving the testing head;

means for pivoting the testing head;

means for tilting the testing head; and

means for rotating the testing head.

### BRIEF DESCRIPTION OF THE DRAWINGS

For a more complete understanding of example embodiments of the present disclosure, reference is now made to the following descriptions taken in connection with the accompanying drawings in which:

FIG. 1 a depicts as a perspective view a testing apparatus according to an example embodiment;

FIG. 1b depicts as a perspective view of a detail of the testing apparatus of FIG. 1a;

FIGS. 2a-2f illustrate movements of a testing head in six different directions according to an example embodiment;

FIG. 3a illustrates a principle of arranging some elements of the testing apparatus inside the testing head according to an example embodiment;

FIG. 3b illustrates as a top view an example of attaching a device under test with the testing head according to an example embodiment;

FIG. 3c illustrates as a front view the example of FIG. 3b;

FIG. 4 shows a simplified block diagram of a testing apparatus according to an example embodiment;

FIGS. 5a and 5b illustrate another mechanical construction of the testing apparatus in a simplified manner; and

FIGS. 6a-6f illustrate different degrees of freedom of the testing apparatus in a simplified manner.

### DETAILED DESCRIPTION OF SOME EXAMPLE EMBODIMENTS

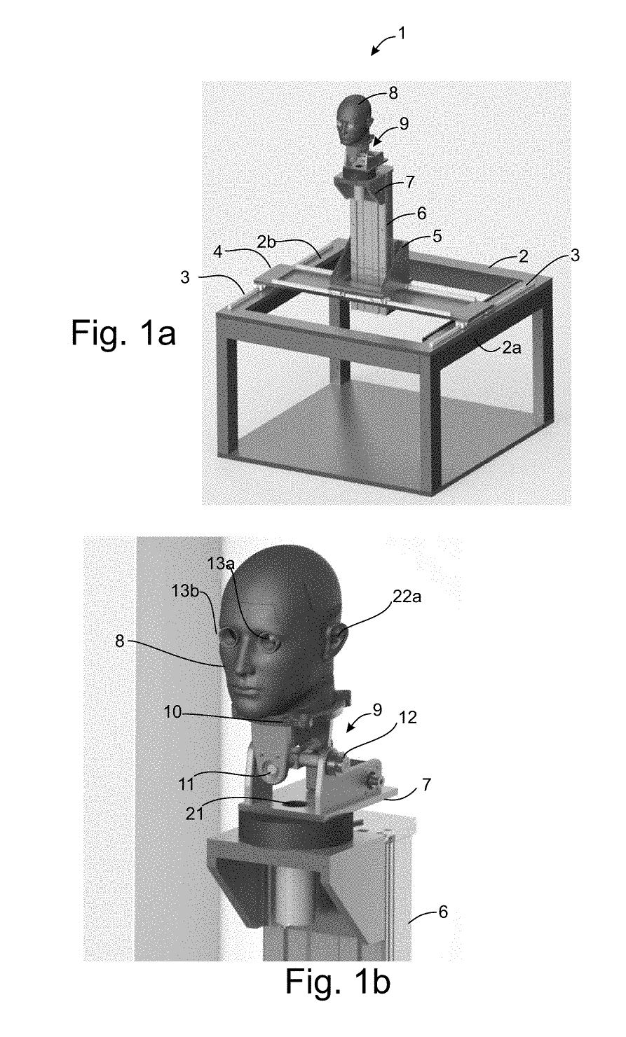

In the following an example embodiment of a testing apparatus 1 will be described. FIG. 1a is a perspective view of the testing apparatus 1, in accordance with an embodiment. The testing apparatus 1 comprises a base part 2 for supporting other parts of the testing apparatus 1. First movement rails 3 are attached with the base part 2, for example at the top of frames 2a, 2b of the base part 2. A first movement platform 4 can be positioned on top of the first movement rails 3 so that the first movement platform 4 can be moved in a first direction, which in this description may also be called as an x-direction.

A second movement platform 5 is attached with the first movement platform 4 so that the second movement platform 5 can be moved e.g. slid in a second direction on the first movement platform 4. This second direction may also be called as an y-direction in this description. The second movement platform 5 has a first support 6 which can be moved vertically (a third direction) with reference to the first movement platform 4. Hence, the first support 6 may also be called as a vertical support in this description. The third direction may also be called as a z-direction in this description. At the top of the vertical support 6 is a second support 7 for supporting a testing head 8 and a movement mechanism 9 for moving the testing head 8. The second support 6 may also be called as a bracket in this description. The movement mechanism 9 comprises a support part 10 at the top of which the testing head 8 is fixed. The support part 10 is adapted to be pivotable with the help of a first axis 11 and tiltable with the help of a second axis 12. Furthermore, the support part 10 is adapted to be rotatable with reference to the bracket 7 e.g. by a third axes 21 which may be an axes of a rotor of a motor or an axes coupled with a transmission mechanism with the axes of the rotor of the motor. For simplicity, the axes and the rotor of the motor are not depicted in the figures.

On the basis of the above described movements it can be deduced that the testing head 8 has six degrees of freedom (DoF): x-, y- and z-direction, rotation, pivoting and tilting. Due to the fact that the movements are not arranged in a traditional way known from robotic arms, an inaccuracy in one movement direction does not have any or only a very small effect to the accuracy of movements in other directions. As an example, if the movement arrangement in the x-direction tends to drift, it does not have any effect to the location and movement of the testing head in other directions.

It should be noted that FIGS. 1a and 1b do not show any details of the movement arrangements of the testing apparatus 1 but a skilled person is aware how to implement the movement arrangements using the above description as a guidance.

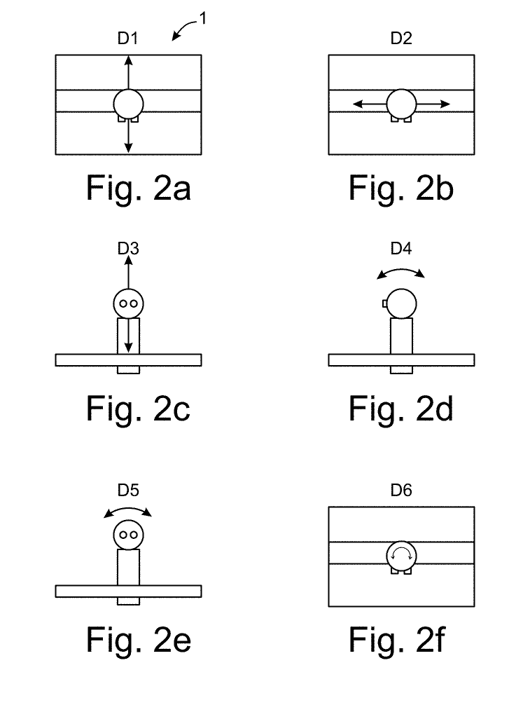

FIGS. 2a-2f illustrate in a simplified manner the above mentioned movements of the testing head 8 in six different directions D1-D6 according to an example embodiment. In FIG. 2a a first degree of freedom D1 is illustrated. In this example this direction is the x-direction i.e. the forward-backward direction in the setup of FIG. 2a. FIG. 2b illustrates a second degree of freedom D2, which is the y-direction in this example, i.e. the right-left direction in the setup of FIG. 2b. FIG. 2c illustrates a third degree of freedom D3, which is the z-direction in this example, i.e. the right-left direction in the setup of FIG. 2c. FIG. 2d illustrates a fourth degree of freedom D4, which is the pivoting the head in this example. FIG. 2e illustrates a fifth degree of freedom D5, which is the tilting the head in this example. FIG. 2f illustrates a sixth degree of freedom D6, which is the rotation of the head in this example. In this description pivoting means the movement in which the head is tilted forward or backwards, and tilting means the movement in which the head is tilted to the left or to the right.

It should be noted that moving something in a first/second/etc. direction may mean back and forth—kinds of movements. In other words, although it is said that an entity is moved in one direction, it means that the entity can be moved farther away from a first location and also back towards the first location following the same path. In this example the first, second and third directions are linear, but some of the other directions may also be angular directions, wherein an entity may be rotated i.e. the path of the movement is circular or elliptic. In accordance with an embodiment, also the rotation may be back-and-forth type of rotation, but in accordance with another embodiment, the rotation may be one way only, meaning that the entity is always rotated in the same direction. Hence, after 360-degrees rotation the entity returns to a starting location.

In the following, some details of the movement arrangements of the testing apparatus 1 will be shortly described. The first movement platform 4 can be moved by e.g. a motor (not shown), which may rotate either directly or via a gear a first force transfer mechanism such as a chain or a belt, or it may be a linear motor generating linear movement to the first movement platform. The chain or belt is coupled with the first movement platform 4, wherein the movement of the chain or belt moves the first movement platform 4. Another option is to provide a rotor of the motor with a cogwheel, attach the motor with the first movement platform 4 and arrange a cogged bar to the base part 2 so that the cogwheel and the cogged part mutually interact. Hence, rotating the rotor rotates the cogwheel, which induces movement of the first movement platform 4. On the other hand, it may be possible to attach the motor having the cogwheel with the base part 2 and arrange the cogged bar to the first movement platform 4 so that the cogwheel and the cogged part mutually interact. Hence, rotating the rotor rotates the cogwheel, which induces movement of the cogged bar and the first movement platform 4. It should be noted that the above mentioned examples are only showing some alternative movement arrangements but also other kinds of arrangements may be used.

Moving the second movement platform 5 may also be arranged similar to the movement of the first movement platform 4 by another motor (not shown), which may rotate either directly or via a gear a second force transfer mechanism, such as a chain, a belt or a cogged bar, as was described above.

A third motor and some appropriate third force transfer mechanism, such as a chain, a belt or a cogged bar, may be used to move the vertical support 6 in the vertical direction. The principles presented above may also be applicable in this context.

A fourth motor may be attached with the bracket 7 at the top of the vertical support 6. Rotation of a rotor of the fourth motor induces rotation of the support part 10. There may be a fourth force transfer mechanism, or the support part 10 may be directly coupled with the rotor of the fourth motor.

A fifth motor may be coupled with the first axis 11 to effect pivoting the testing head 8 and a sixth motor may be coupled with the second axis 12 to effect tilting the testing head 8.

All the motors or some of them may be so called step motors which can be positioned quite accurately to a desired position, linear motors effecting linear movement, as was already mentioned above. However, it may also be possible to use other kinds of electric motors as well. It may also be possible to implement some or all the above described movements using hydraulic actuators, pneumatic actuators, or some other appropriate force generating/delivering apparatus.

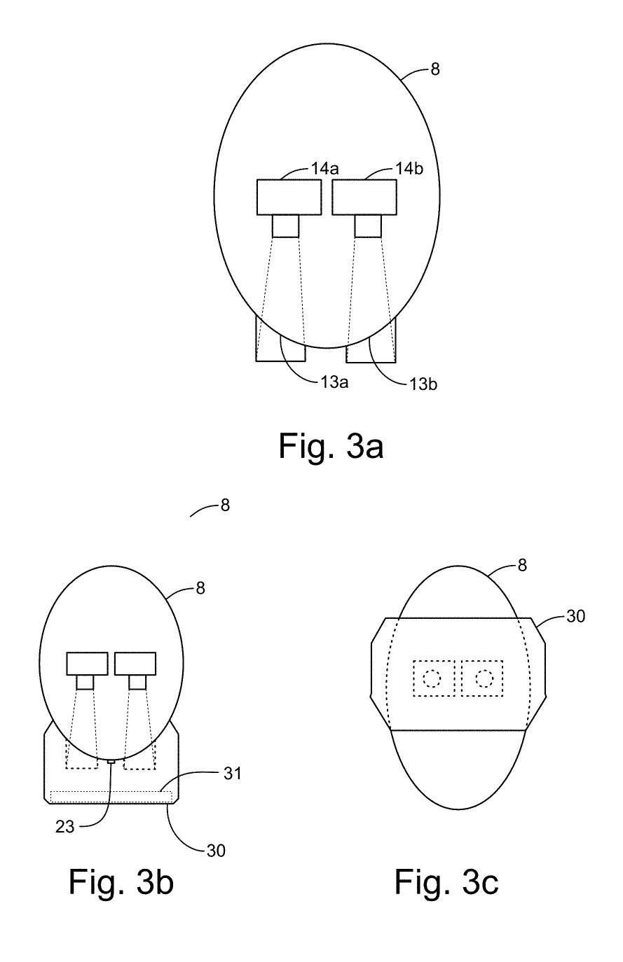

FIG. 3a illustrates a principle of arranging some elements of the testing apparatus 1 inside the testing head 8 according to an example embodiment. In this example the testing head 8 comprises two openings imitating eyes of a human person. Behind the eyes are two cameras 14a, 14b for imaging the view through the openings 13a, 13b. The openings 13a, 13b may also be provided with lenses which may affect the focus of the optical system of the testing head 8. In other words, the lenses may be used to adjust the sharpness of images captured by the cameras 14a, 14b, to change the angle of view the cameras 14a, 14b see, etc. The testing head 8 may also comprise one or more microphones 22a, 22b to record audio for audio measurements.

FIG. 3b illustrates as a top view an example of attaching the device under test 30 with the testing head 8 according to an example embodiment, and FIG. 3c illustrates as a front view the example of FIG. 3b. A display 31 of the device under test 30 is located in front of the openings 13a, 13b so that the cameras 14a, 14b have a view to appropriate sections of the display 31. In this example, information of the display 31 is arranged so that the left part of the display 31 is seen by the first camera 14a and the right part of the display 31 is seen by the second camera 14a. The terms left part and right part refer to the arrangement of FIGS. 3b and 3c. The device under test 30 could also have separate displays (not shown in the Figures) so that the first camera 14a sees the information displayed by the first display and the second camera 14b sees the information displayed by the second display.

It may happen that moving the testing head 8 may cause some undesirable movements of the device under test 30. To eliminate or at least reduce such movements the testing head 8 may comprise, for example, a groove at a location to which an edge of the device under test 30 will rest against the surface of the testing head 8. Hence, the groove may prevent the movement of the device under test 30 with respect to the testing head 8. In accordance with an embodiment, there are several grooves designed for different models of the device under test 30. It may also be possible to form spikes or some other kind of protrusions at a bottom of the groove to further improve the friction between the testing head 8 and the device under test 30. An edge of the device under test 30 may comprise a padding which softens the pressure against a user's head when s/he puts such a device on.

In accordance with an embodiment, the testing head 8 may also have a sensor 23 (illustrated in FIG. 3b), such as an optical sensor, preferably at a location of the padding. The sensor 23 may be used to measure the movement of the device under test 30 during the test. The sensor 32 may, for example, produce location information e.g. as x,y-coordinates which may then be used to determine possible differences of movements of the testing head 8 and the device under test 30.

In accordance with an embodiment, the testing apparatus 1 only comprises one camera instead of the two cameras 14a, 14b. Hence, the image captured by the camera may be analyzed and handled by a testing software so that that part of the image which is induced by optical signals travelled through the first opening 13a shall be treated in the same way than images of the first camera 14a in the two-camera embodiment and, respectively, that part of the image which is induced by optical signals travelled through the second opening 13b shall be treated in the same way than images of the second camera 14b in the two-camera embodiment.

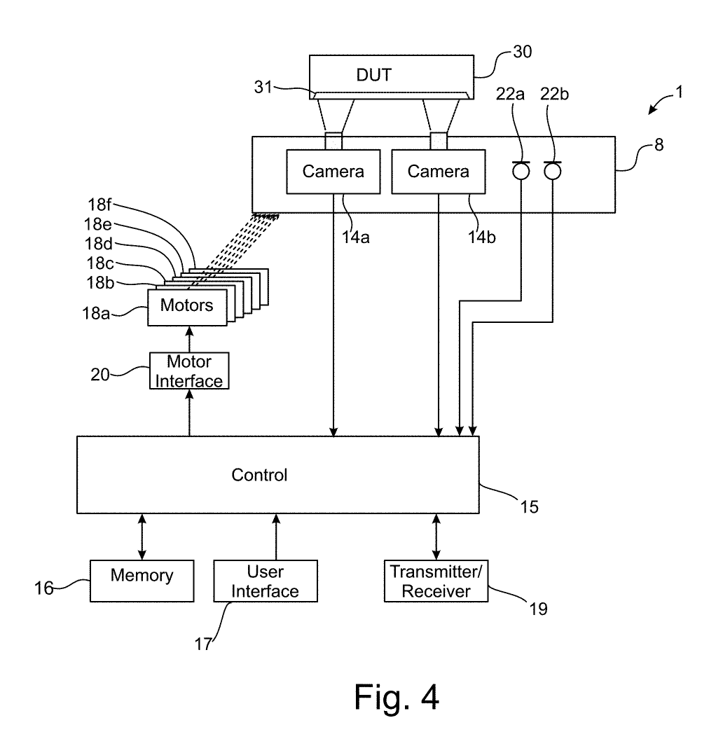

FIG. 4 shows a simplified block diagram of the testing apparatus 1 according to an example embodiment. The testing apparatus 1 comprises a processing entity such as a processor 15 for controlling the operation of the testing apparatus 1. The testing apparatus 1 may further comprise a memory 16 for storing data, computer code etc., and a user interface 17 for enabling a user to input instructions, data etc. to the testing apparatus and to show the user test results, images captured by the cameras 14a, 14b, etc. The testing apparatus 1 also comprises one or more motors 18a-18f for moving the testing head 8, as was described above. The testing apparatus 1 may further comprise communication means 19 to communicate e.g. with a device to be tested or with a communication network. There is also an interface 20 for providing control signals to the motors 18a-18f.

In the following, using the testing apparatus 1 to test a device under test (DUT) 30 will be shortly described. The device under test 30 is put on the testing head 8 so that a display 31 of the device under test 30 is in front of the openings 13a, 13b. A test procedure may be started in the testing apparatus 1. A video or another application which produces visual information on the display 31 of the device under test 30 may be started, for example, under the control of the testing apparatus 1 or manually. The cameras 14a, 14b start capturing images which may be analyzed by an analysis program in the processor 15. The processor 15 may also generate signals to the interface 20 to move the testing head 8 to a desired position, to tilt, pivot and/or rotate the testing head 8 as needed. Therefore, different kinds of testing situations may be generated and results handled by the testing apparatus 1.

In accordance with an embodiment, all or a part of the measurement data provided by camera(s), microphone(s) etc. may be provided to an apparatus external to the testing apparatus 1 (not shown in the figures), wherein processing the information may be performed by the other apparatus instead of or in addition to the testing apparatus 1.

One issue to be taken into account in the control of the testing apparatus 1 is that the measurement data is synchronized so that responses to generated motions can be detected at reasonable accuracy. As an example, if the testing head 8 is turned slightly by the fourth motor 18d, the response shown by the display 31 and captured by the camera 14a, 14b is detected. This may be performed, for example, so that information when the control signal is generated to the fourth motor 18d is provided to the processor 15 or to the other device, if any, wherein the captured image at the moment of the movement can be assigned with the information of the movement of the fourth motor 18d.

The mechanical construction of the testing apparatus 1 may also differ from the embodiment depicted in FIGS. 1a and 1 b. Similar movements may be implemented by some other appropriate means to obtain six degrees of movements of the testing head 8 so that inaccuracies in one movement direction will not induce inaccuracies in other movement directions.

It should also be noted that the testing apparatus 1 may comprise more than six degrees of freedom. As an example, the testing apparatus 1 may comprise gripping elements simulating both hands of a human, and actuators for moving the hands in one or more ways. Each of the two hands could have six degrees of freedom wherein the testing apparatus could have three times six degrees of freedom. i.e. 18 degrees of freedom.

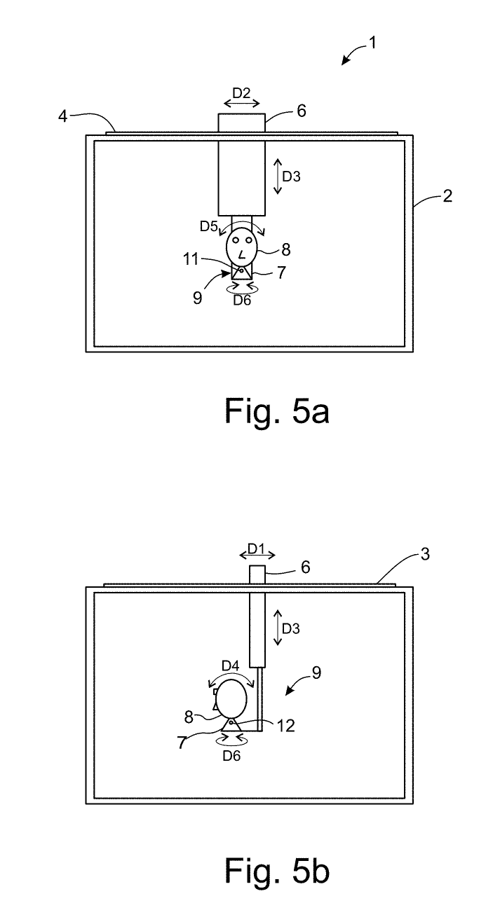

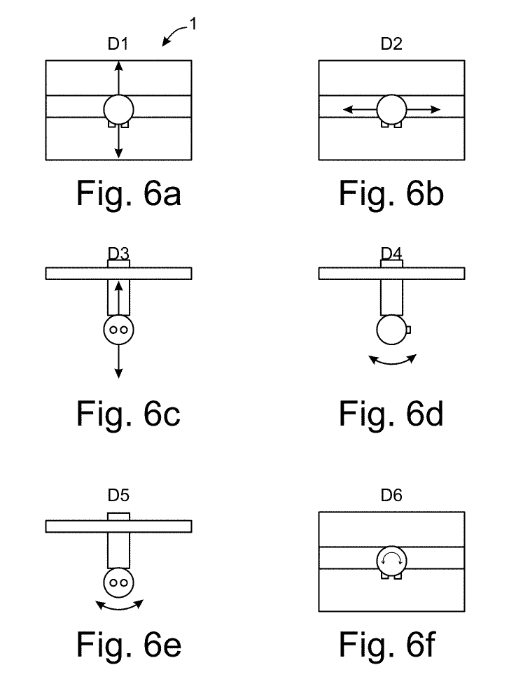

FIGS. 5a and 5b illustrate another mechanical construction of the testing apparatus 1 in a simplified manner, and FIGS. 6a-6f illustrate different degrees of freedom of the testing apparatus 1, also in a simplified manner. In this embodiment the head 8 is positioned below the xyz-moving mechanics whereas in the embodiment of FIGS. 1a and 1b the head 8 is positioned above the xyz-moving mechanics. This may enable a more flexible measuring arrangement so that the head 8 can be moved in a larger scale. For example, the testing apparatus 1 of FIGS. 5a and 5b may be implemented so that it almost utilizes a whole space of a room wherein the head 8 can be moved to almost every location within the room. Furthermore, when this embodiment is implemented, it may be possible to add different kinds of furniture inside the room and thus more realistic environment may be obtained for the testing purposes.

FIGS. 6a-6f illustrate in a simplified manner the movements of the testing head 8 in six different directions D1-D6 of the testing apparatus of the example embodiment of FIGS. 5a and 5b. In FIG. 6a a first degree of freedom D1 is illustrated. In this example this direction is the x-direction i.e. the forward-backward direction in the setup of FIG. 6a. FIG. 6b illustrates a second degree of freedom D2, which is the y-direction in this example, i.e. the right-left direction in the setup of FIG. 6b. FIG. 6c illustrates a third degree of freedom D3, which is the z-direction in this example, i.e. the right-left direction in the setup of FIG. 6c. FIG. 6d illustrates a fourth degree of freedom D4, which is the pivoting the head in this example. FIG. 6e illustrates a fifth degree of freedom D5, which is the tilting the head in this example. FIG. 6f illustrates a sixth degree of freedom D6, which is the rotation of the head in this example.

To exchange information, commands, responses etc. a communication connection between the device under test and the testing apparatus 1 may be created. It may be a wireless communication connection, such as a short range wireless communication connection and/or a mobile telecommunication connection, or a wired communication connection, or both.

The information may comprise, for example, some specifications of the device under test 30, such as a type of the device 30, a resolution of the display(s) 31 of the device, a pose of the camera in virtual reality, etc.

In accordance with an embodiment, so called QR-codes, bar codes or other visual coding arrangement may be utilized in the information exchange. For example, the device under test 30 may display one or more QR-codes on the display 31, wherein the testing apparatus may decode the information carried by the QR-code.

The testing apparatus 1 may be calibrated so that the different degrees of movements are mutually calibrated. This may be performed e.g. in such a way that the testing head 8 is turned, pivoted, rotated and/or moved until the camera has in view one or more calibration targets attached with, for example, the base part 2. The location of the one or more calibration targets is known wherein when the testing apparatus 1 determines that a calibration target is e.g. in the centre of view of the camera, the location and pose of the testing head 8 is known. The procedure may be repeated for several calibration targets to obtain calibration of each degree of freedom. The calibration target may be a certain kind of optical pattern such as a cross, a point, a QR-code, wherein the QR-code may contain information of the calibration target such as location of the target, etc.

As an example of a use of the testing apparatus is to detect latency and/or drifting. Latency may be determined by moving the testing head and capturing images of the view of the camera, wherein the delay between the actual movement and the response seen by the camera is an indication of the latency. Drifting means in this context an unintentional movement of the image shown by the display of the device under test. This may be measured e.g. so that the device under test is instructed to display a tag or some other visual object on the display at some location. When the testing head 8 is moved or rotated, the location of the tag should change so that it moves in a reversed direction thus simulating a situation in which the tag does not move with reference to the base part of the testing apparatus. The testing apparatus captures images from the display and determines the location of the tag on the display. When the movement of the testing head is repeated so that after the movement the testing head is returned to the initial position, the tag should be located in the initial position on the display. If, after several repetitions the tag has moved to a different location, the difference between the initial location and the different location may be used to determine the drift.

In the following some examples will be provided.

According to a first example, there is provided a testing apparatus 1 comprising:

a base part 2;

a testing head 8;

a first movement platform 4 positioned on top of the base part 2 adapted to be movable in a first direction with respect to the base part 2;

a second movement platform 5 attached with the first movement platform 4 so that the second movement platform 5 is adapted to be movable in a second direction transverse to the first direction with respect to the base part 2;

a first support 6 adapted to be movable in a third direction transverse to the first direction and the second direction;

a movement mechanism 9 for moving the testing head 8;

a second support 7 attached with the vertical support for supporting the movement mechanism 9 and the testing head 8;

wherein the movement mechanism 9 comprises:

a first axis 11 for pivoting the testing head 8;

a second axis 12 for tilting the testing head 8; and

a third axes 21 for rotating the testing head 8.

In some embodiments the testing apparatus 1 further comprises

a set of motors 18a-18f adapted to induce movements of the testing head 8 in at least six directions.

In some embodiments the testing apparatus 1 further comprises

first movement rails 3 attached with the base part 2, wherein the first movement platform 4 is positioned on top of the first movement rails 3 to enable the movement of the first movement platform 4 in the first direction.

In some embodiments of the testing apparatus the testing head comprises one or more of the following:

one or more cameras 14a, 14b;

one or more microphones 22a, 22b.

In some embodiments the testing apparatus 1 further comprises gripping elements to simulate human hands.

In some embodiments of the testing apparatus 1 the gripping elements are adapted to be movable in three different directions.

We claim:

1. A testing apparatus comprising:
a base part;
a testing head;
a first movement platform positioned on top of the base part adapted to be movable in a first direction with respect to the base part;
a second movement platform attached with the first movement platform so that the second movement platform is adapted to be movable in a second direction transverse to the first direction with respect to the base part;
a first support adapted to be movable in a third direction transverse to the first direction and the second direction;
a movement mechanism for moving the testing head;
a second support attached with the vertical support for supporting the movement mechanism and the testing head;
wherein the movement mechanism comprises:
a first axis for pivoting the testing head;
a second axis for tilting the testing head; and
a third axes for rotating the testing head.

2. The testing apparatus according to claim 1 further comprising:
a set of motors adapted to induce movements of the testing head in at least six directions.

3. The testing apparatus according to claim 1 further comprising:
first movement rails attached with the base part, wherein the first movement platform is positioned on top of the first movement rails to enable the movement of the first movement platform in the first direction.

4. The testing apparatus according to claim 1, wherein the testing head comprises one or more of the following:
one or more cameras;
one or more microphones.

5. The testing apparatus according to claim 1 further comprising:
gripping elements to simulate human hands.

6. The testing apparatus according to claim 5, wherein the gripping elements are adapted to be movable in three different directions.

7. The testing apparatus according to claim 1, wherein the testing head is above the first support.

8. The testing apparatus according to claim 1, wherein the testing head is below the first support.

9. A method for testing a device by a testing apparatus, wherein the testing apparatus comprises:
a base part;
a testing head;
a first movement platform positioned on top of the base part adapted to be movable in a first direction with respect to the base part;
a second movement platform attached with the first movement platform so that the second movement platform is adapted to be movable in a second direction transverse to the first direction with respect to the base part;
a first support adapted to be movable in a third direction transverse to the first direction and the second direction;
a movement mechanism for moving the testing head;
a second support attached with the vertical support for supporting the movement mechanism and the testing head;
wherein the method comprises:
instructing the device to run an application for producing video information on a display of the device or audio information by the device or both;
moving the testing head in at least one direction;
capturing by the testing apparatus information produced by the device;
examining the captured information to determine response of the device to the movement of the testing head.

10. The method according to claim 9, wherein the examining comprises one or more of the following:
determining latency of the display of the device;
determining drifting of the display of the device.

11. A testing apparatus comprising:
a base part;
a testing head;
a first movement platform positioned on top of the base part;
means for moving the first movement platform in a first direction with respect to the base part;
a second movement platform attached with the first movement platform;
means for moving the second movement platform in a second direction transverse to the first direction with respect to the base part;
a first support;
means for moving the first support in a third direction transverse to the first direction and the second direction;
means for moving the testing head;
means for pivoting the testing head;
means for tilting the testing head; and
means for rotating the testing head.
